(19) United States
(12) Patent Application Publication
(10) Pub. No.: US 2015/0226115 A1
(43) Pub. Date: Aug. 13, 2015

(54) ASSEMBLY COMPRISING A GENERATOR AND ELECTRIC MOTORS, FOR A VEHICLE COOLING OR AIR-CONDITIONING SYSTEM

(71) Applicant: MOTEURS LEROY-SOMER, Angouleme (FR)

(72) Inventors: Régis Giraud, Angouleme (FR); Stéphane Dedieu, Angouleme (FR)

(21) Appl. No.: 14/415,996

(22) PCT Filed: Jul. 17, 2013
(86) PCT No.: PCT/IB2013/055885

§ 371 Date: Jan. 20, 2015

(30) Foreign Application Priority Data
Jul. 19, 2012 (FR) 1257007

(51) Int. Cl. F02B 63/04; F02B 67/06; F01P 9/06; B60R 16/03

(52) U.S. Cl. CPC F02B 63/042; B60R 16/03; F02B 67/06; F01P 9/06

(57) ABSTRACT

An assembly including: a diesel heat engine driving a compressor; a generator having permanent magnets and a four-pole rotor, the generator shaft being rotated by the heat engine via a belt pulley system; one or more electric motors for the condenser(s) and/or evaporator(s) of a vehicle cooling or air-conditioning system, the generator directly powering the motor(s) and the supply voltage of the motor(s) being the generator output voltage; an auxiliary electric motor for driving the compressor when it is not or cannot be driven by the heat engine; and a device for toggling the power supply of the electric motor(s) of the condenser(s) and/or evaporator(s) of the cooling or air-conditioning system, by which it is possible to switch from power being supplied by the generator to an external electric network, said toggle device including one or more switches for controlling the power supply of the motor(s) from the electric network.

The present invention concerns the production of electricity from an assembly comprising an internal combustion engine and an electricity generating device for powering one or more electric motors.

There is a need to simplify and facilitate the drive of the cooling or air-conditioning system and reduce the cost of the electricity generating device.

The invention is aimed in particular at meeting this need and its object is therefore an assembly comprising:
an internal combustion engine,
a generator, the shaft of which is driven in rotation by the internal combustion engine, and
one or more electric motors, in particular of a vehicle cooling or air-conditioning system, the generator directly powering the electric motor(s), the supply voltage of the electric motor(s) being the generator output voltage.

The electric motor(s) may each serve to drive a fan and be a motor for a condenser and/or evaporator.

Each motor according to the invention is directly connected to the generator without any intermediate electronic device, such as a voltage regulator or inverter, which allows a reduction in the cost of the assembly. The assembly according to the invention therefore requires no inverter. No continuous bus connection is required to supply said motor.

The assembly may comprise a single condenser or as a variant several condensers. The assembly may for example comprise two condensers. The assembly may comprise a single evaporator or as a variant several evaporators. The assembly may for example comprise two evaporators.

The motor(s) may be asynchronous or synchronous motors. They may be three-phase motors. They may be single- or two-speed motors, which allows similar ventilation performances to be achieved irrespective of the speed of the internal combustion engine. The absorbed power can therefore be limited when the speed of the internal combustion engine is increased. The rotation speeds of the internal combustion engine may for example be as follows: 1600 rpm and 2200 rpm.

The motor(s) are preferably asynchronous motors which have a simple structure and are reliable to use. Thus the U/F ratio at the motor terminals is constant, which is possible thanks to supply by the generator. In the case where the speed of the internal combustion engine falls, the voltage will also fall but the ratio will remain constant. If the speed is too low, the coupling may be changed to switch to another polarity in the case where the motor is a two-speed motor.

The motor(s) may have no permanent magnets, or as a variant may comprise permanent magnets.

One or at least one of the motors may comprise a four-pole or a six-pole rotor, which allows function at low speed with low consumed power.

The motor(s) may comprise a fan at each of the free ends of the shaft.

The internal combustion engine may be a diesel engine. The internal combustion engine and the electric motor(s) may belong to a vehicle cooling or air-conditioning system. The internal combustion engine may be distinct from the engine used to propel the vehicle.

The generator is a synchronous machine.

The internal combustion engine may drive the generator shaft via a pulley-belt system. Such a drive by pulley-belt system allows adjustment of the generator output frequency to the speed of the internal combustion engine, so as to allow the use of electric fan motors which can be used directly on the supply network without loss of performance. For example, the motor(s) may be designed to function at 230 V and 50 Hz, but may also function at 207 V and 45 Hz, since to do this the generator may be driven at 1350 rpm. If the internal combustion engine has a rotation speed of 1600 rpm with a ratio of 1.125 between the pulleys, then the generator, with four poles for example, would be driven at a speed of 1800 rpm and supply an output voltage at 60 Hz like the network, thanks to its synchronous construction which induces no slippage.

The generator may therefore be driven in rotation by the internal combustion engine with a transmission ratio selected such that the frequency supplied by the generator is the same as that of the external electrical network used to power the motors when the vehicle is stopped.

The frequency supplied by the generator may be linked to its rotation frequency N by the formula f=p*N/2π, wherein p is the number of pairs of poles, and N in rad/s. For a four-pole structure, we have f=N/ρ with p=2.

The generator may comprise permanent magnets. The generator rotor may comprise permanent magnets, then being for example a flux concentration or embedded magnet rotor.

The assembly may comprise a device for switching the supply of the electric motor(s), allowing switching from supply by the generator to supply by an electrical network. In this case, the motor(s) are connected directly to the network and the generator is then isolated.

The switching device may be configured to trigger only when the vehicle has stopped, which avoids the pollution which may be caused by the operation of the internal combustion engine while at a standstill. The switching device may comprise one or more switches allowing the supply of the electric motor(s) to be controlled from the electrical network. The or each switch may comprise one or more electronic components. The or each switch may be produced by any suitable means, and for example using one or more electromechanical or semiconductor switches, for example with contactor(s), relay(s), thyristor(s), triac(s), IGBT or bipolar transistor(s).

The motor(s) may function on an external electrical network such as a network with 230 V and 60 Hz, or 460 V and 60 Hz, or again 400 V et 50 Hz. As a further variant, the motor(s) may be multi-voltage and multi-frequency motors. They may also function with an electrical network at 50 Hz. Thus these motors can function on electrical networks throughout the entire world, as they can be adapted to any place of use and the characteristics of the local electrical network.

The assembly may also comprise a compressor driven mechanically by the internal combustion engine. The drive may take place by pulley-belt system. The assembly need not have a compressor driven by an electric motor, at least in normal operation of the assembly.

The assembly may also comprise an auxiliary electric motor for driving the compressor when the latter is not or cannot be driven by the internal combustion engine. The drive may take place by pulley-belt system. This auxiliary electric motor may be powered from the electrical network.

As a variant or in addition, the assembly may comprise an electrical compressor powered by the generator. The compressor may comprise an electrical motor for the compressor and a pump driven by said motor, both being arranged in a sealed housing. In other words, the assembly may comprise a hermetic compressor. The electrical compressor may be powered directly by the generator. The supply voltage of the electrical compressor may be the generator output voltage.

The assembly may comprise no batteries.

The invention will be better understood from reading the detailed description below of non-limitative exemplary embodiments, and from examination of the attached drawing on which:

FIG. 1 shows diagrammatically an assembly, possibly on board a vehicle, fitted with an electricity generating device produced in accordance with the invention,

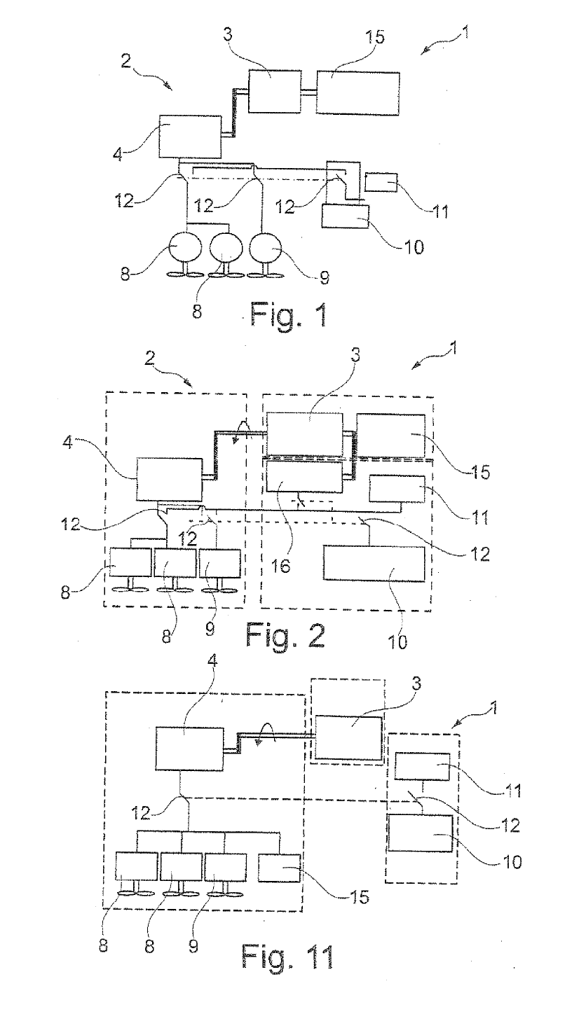

FIG. 2 is a view similar to FIG. 1 of a variant embodiment,

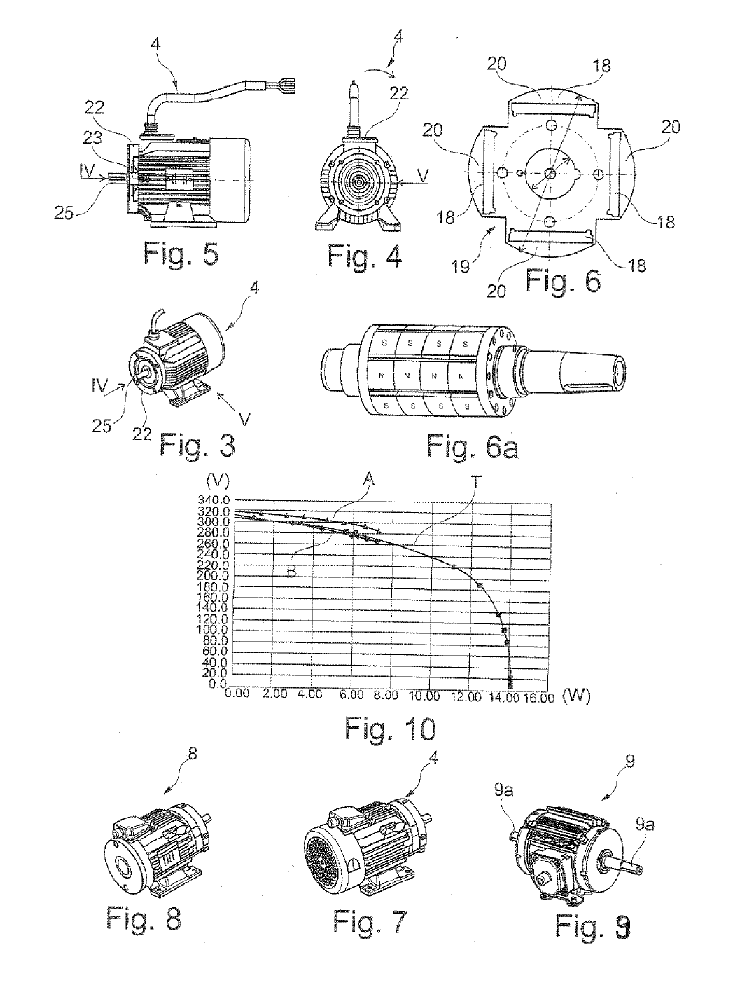

FIG. 3 is a perspective view of a generator which may be used in the invention,

FIGS. 4 and 5 are views along arrows IV and V respectively of FIG. 3,

FIG. 6 is a diagrammatic, partial, cross-section view of the rotor of the generator in FIGS. 3 to 5,

FIG. 6a is a diagrammatic, partial, perspective view of the rotor of a variant embodiment of the generator,

FIG. 7 is a diagrammatic, partial, perspective view of a variant embodiment of the generator,

FIGS. 8 and 9 are diagrammatic, partial, perspective views of the condenser and evaporator motors respectively according to the invention,

FIG. 10 shows the variation in output voltage of the generator in relation to the supplied power, and

FIG. 11 is a view similar to FIG. 1 of a variant embodiment.

FIG. 1 shows an assembly 1 comprising firstly an internal combustion engine 3 and secondly an electricity generating device 2 with a generator 4, the shaft of which may be driven in rotation by the internal combustion engine 3. The assembly 1 is for example mounted on board a vehicle. In the example described, the internal combustion engine is a diesel engine.

The assembly also comprises electric motors of a vehicle cooling or air-conditioning system, powered by the electricity generating device 2. In the example described, the assembly comprises two condenser motors 8 and one evaporator motor 9.

The electricity generating device 2 is configured such that the generator powers the electric motors directly, i.e. the supply voltage of the electric motors is the output voltage of the generator 4.

In the example described, the assembly also comprises a device 10 for switching the power supply of the electric motors of the condensers and the evaporator, allowing switching from supply by the generator to supply by an external electrical network 11. The switching device 10 comprises switches 12 allowing the power supply of the electric motors to be controlled from the electrical network 11.

The assembly comprises a compressor 15 driven by the internal combustion engine 2. The drive may take place by pulley-belt system. The assembly therefore has no electrically driven compressor.

The assembly may also, as shown on FIG. 2, comprise an auxiliary electric motor 16 for driving the compressor 15 when the latter is not or cannot be driven by the internal combustion engine. The drive may take place by pulley-belt system. This auxiliary electric motor may be powered from the electrical network 11. Despite the presence of the auxiliary electric motor 16, the assembly has no electrically driven compressor in normal operating mode of the assembly.

The generator 4 has been shown in detail in FIGS. 3 to 6. It may comprise a wound stator with a segmented winding. The rotor may comprise permanent magnets or be wound. In the example described, it comprises a rotor 19 with permanent magnets 18 embedded below the surface of the poles 20, as shown in FIG. 6. The rotor illustrated comprises four poles 20.

The generator comprises a flange 22 allowing the removal of a bearing 23 arranged at the front of the generator.

The internal combustion engine 3 also drives the shaft 25 of the generator 4 by a pulley-belt system, which allows adjustment of the generator output frequency to the speed of the internal combustion engine. The internal combustion engine 3 may drive the generator 4 at a variable speed. For example, when the generator charge is low, the rotation speed of the internal combustion engine 3 is relatively low, and when the generator charge 3 increases, the speed of the internal combustion engine 3 may be increased.

FIG. 7 shows an exemplary embodiment in which the generator 7 comprises a stator with segmented winding and a rotor with embedded permanent magnets and four poles. This generator for example has a power of 3.5 kVA at an operating speed of 1800 rpm.

The generator may comprise 8 poles without leaving the framework of the present invention.

FIG. 8 shows an exemplary embodiment of the condenser motor 8. The motor 8 in this example has a four-pole rotor.

FIG. 9 shows an exemplary embodiment of the evaporator motor 9. The evaporator comprises for example a fan at each of the free ends 9a of its shaft.

FIG. 10 shows the variation in output voltage of the generator in volts in relation to the supplied power in watts. Curve T illustrates the theoretical values, curve A the values obtained with a generator with embedded permanent magnets as shown in FIG. 6, and curve B with a generator with surface-glued permanent magnets as shown in FIG. 6a.

In the description above, at least in normal operating mode of the assembly, the compressor 15 is driven by the internal combustion engine 3. This situation may vary, without leaving the framework of the present invention, if the electrical compressor 15 is powered by the generator 4. As an example, FIG. 11 shows an assembly comprising an electrical compressor 15 powered directly by the generator 4, the supply voltage of the electrical compressor being the output voltage of the generator 4.

The expression “comprising a” should be understood as synonymous with “comprising at least one” unless specified to the contrary.

1. An assembly comprising:
a diesel internal combustion engine driving a compressor,
a generator with permanent magnets, the four-pole rotor and shaft of which are driven in rotation by the internal combustion engine via a belt-pulley system,
one or more electric motors for the condenser(s) and/or evaporator(s) of a vehicle cooling or air-conditioning system, the generator powering the electric motor(s) directly, the supply voltage of the electric motor(s) being the generator output voltage,
an auxiliary electric motor for driving the compressor when the latter is not or cannot be driven by the internal combustion engine,
a device for switching the power supply of the electric motors of the condenser(s) and/or evaporator(s) of the cooling or air-conditioning system, allowing switching from supply by the generator to supply by an external electrical network, the switching device comprising one or more switches allowing the supply of the electric motors to be controlled from the electrical network.

2. The assembly as claimed in claim 1, the internal combustion engine or the electric motor(s) belonging to a vehicle cooling or air-conditioning system.

3. The assembly as claimed in claim 2, wherein the electric motor(s) serve to drive a fan and are condenser and/or evaporator motors.

4. The assembly as claimed in claim 1, comprising an electrical compressor powered by the generator.

5. The assembly as claimed in claim 1, wherein the one or at least one of the electric motors belongs to a condenser, said motor comprising a four-pole rotor.

6. The assembly as claimed in claim 1, wherein the one or at least one of the electric motors belongs to an evaporator.
